(19) United States
(12) Patent Application Publication
(10) Pub. No.: US 2009/0095070 A1
(43) Pub. Date: Apr. 16, 2009

(54) Sludge Level Probe, Sedimentation Plant and Method for Determining the Sludge Level

(75) Inventors: Manfred Battefeld, Dusseldorf (DE); Andreas Jonak, Meerbusch (DE); Lothar Heidemanns, Korschenbroich (DE); Axel Leyer, Monchengladbach (DE); Michael Schuster, Neuss (DE)

Correspondence Address: GRIFFIN & SZIPL, PC, SUITE PH-1, 2300 NINTH STREET, SOUTH, ARLINGTON, VA, 22204, US

(73) Assignee: HACH LANGE GMBH, Berlin (DE)

(21) Appl. No.: 12/278,468

(22) PCT Filed: Jan. 16, 2007
(86) PCT No.: PCT/EP2007/050415

§ 371 Date: Nov. 4, 2008

(30) Foreign Application Priority Data
Feb. 6, 2006 (EP) 06101319.9

(51) Int. Cl. G01F 23/296

(52) U.S. Cl. 73/290 V; 210/114

(57) ABSTRACT

The invention relates to a sedimentation plant comprising a sedimentation basin (12), a cleaner beam (18) and an ultrasonic sludge level probe (30) which is suspended in the sedimentation basin (12). The cleaner beam (18) collides with the sludge level probe (30) in a regular manner ensuring that the sludge level probe (30) is displaced from the vertical spatial position and that the distance measuring values supplied thereby are no longer required for evaluating the height (h) of the sludge level (40). A positional sensor (34) is associated with the ultrasonic measuring head (32), which determines the spatial position of the ultrasonic measuring head (32). As a result, an error position of the ultrasonic measuring head (32) can be determined and the distance measuring values supplied by the ultrasonic measuring head (32) when in the error position are suppressed when the height (h) of the sludge level (40) is determined.

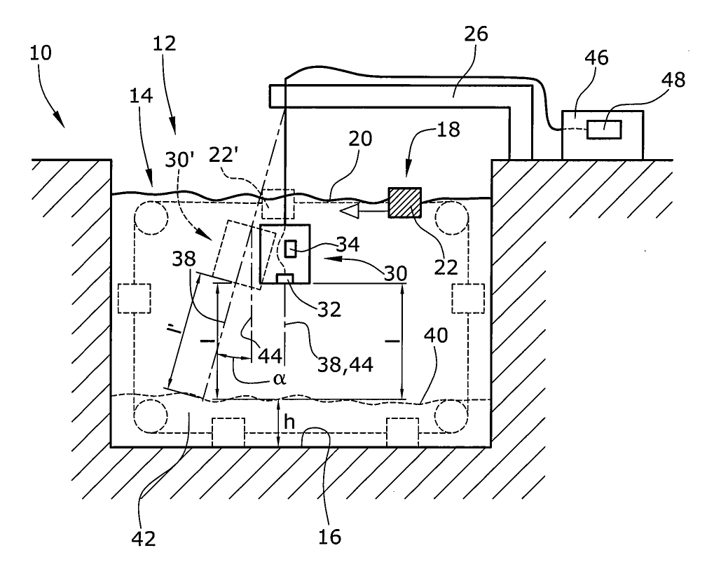

This is a National Phase Application in the United States of Application No. PCT/EP2007/050415 filed Jan. 16, 2007, which claims priority on EP Patent Application No. 06101319.9 filed Febuary, 2006. The entire disclosures of the above patent applications are hereby incorporatedd by reference.

The invention relates to an ultrasonic sludge-level probe comprising a sludge-level ultrasonic measuring head which is held by a holding device and is suspended downward into a liquid, to a sedimentation plant provided with a sludge level probe, and to a method for determining the sludge level.

Ultrasonic sludge-level probes are measuring devices for detecting the sludge level in clear to massively turbid media, particularly in waste water. Said probes serve for monitoring the height and respectively the distance of the separation layer between the liquid and the solids which have sedimented downwardly and sunk, i.e. the height of the sludge level above the ground or the distance of the sludge level from an ultrasonic measuring head of the sludge-level probe. Sludge-level probes of this type are used in the waste- and drinking-water conditioning. The measuring of the height of the sludge level or of the distance of the sludge level from the ultrasonic measuring head is performed on the basis of the travel time of an ultrasonic signal.

Sludge-level probes are normally used in sedimentation basins in which the wastewater liquid will be separated from the solids with the aid of gravity. Those solids which are heavier than the liquid, the latter in the normal case being water, will sink to the bottom and form a layer of sludge there, with the upper boundary layer of the sludge layer forming the sludge level. Those solids which are lighter than water will rise to the surface of the liquid.

The sedimented solids have to be removed from the sedimentation basin at regular intervals. In longitudinal basins, so-called beam-type cleaners are used for this purpose. A beam-type cleaner comprises a plurality of cleaner beams extending across the width of the basin and having their ends fastened to a respective chain. Said beams will be pulled along the bottom of the basin, thus pushing ahead of them the solids which have sunk to the bottom towards a funnel arranged on the longitudinal end of the basin while, from said funnel, the solids will finally be pumped off. Subsequently, the beams will be moved upward along an end wall of the basin and will be returned along the water surface in the longitudinal direction of the basin, thus conveying the risen floating solids to the opposite longitudinal end of the basin.

In the process, the beams are inevitably caused to collide with the sludge-level probe whose ultrasonic measuring head must be immersed into the liquid in a vertically suspended orientation for sludge level detection. The sludge-level probe is suspended from a pivotable linkage structure so that, when the collision occurs, the probe is allowed to evade the beam. Due to its pivotable arrangement, however, the sludge-level probe may happen to be moved out of its vertical orientation also due to other influences, e.g. by wind or flow currents. As soon as the ultrasonic measuring head is not arranged in a vertical orientation anymore, its distance to the sludge level will be measured not vertically anymore but, instead, at an angle of inclination which corresponds to the spatial position of the ultrasonic measuring head and respectively its axial line relative to the vertical line. The measurement values supplied by an ultrasonic measuring head not oriented along the vertical line, i.e. in its desired position, do not represent the actual height of the separation layer or the actual distance of the sludge level but, due to the non-vertical measurement axis, are erroneous measurement values which should not be passed on for further evaluation.

### SUMMARY OF THE INVENTION

Thus, it is an object of the invention to provide a sludge level probe, a sedimentation plant and a method for determining the sludge level, respectively, which are adapted to perform an error-free determination of the sludge level height.

As provided by the invention, a positional sensor is associated with the ultrasonic measuring head for determining the spatial position of the ultrasonic measuring head. Thus, with the aid of the positional sensor, the spatial position of the ultrasonic measuring head can be determined at all times and in a continuous manner. It can be detected at all times whether the ultrasonic measuring head is in a vertical position, i.e. whether the measurement axis and respectively the axial line of the ultrasonic measuring head is arranged vertically or not. Thus, the spatial position in the present context is always to be understood as the rotatory orientation in space, and not as the translatory position.

By use of the positional sensor which is rigidly connected to the ultrasonic measuring head, each non-verticality of the ultrasonic measuring head can be detected directly and without delay, and the measuring signals generated during its non-verticality can be corrected directly or not be supplied to any further evaluation process anymore. In this manner, it can be prevented—particularly in sedimentation basins with beam-type cleaners—that the useless measurement values caused by the regular and unavoidable collisions of the cleaner beams with the ultrasonic measuring head, can be supplied to a further evaluation process uncorrected or can be supplied at all. For deleting the useless distance measurement values resulting from the collisions of the beam-type cleaners, it is thus not required anymore to determine the position of the beam-type cleaner, to detect faulty distance measurement values with the aid of mathematical or statistical values, or to employ other complex methods and devices for identification of useless distance measurement values or for avoidance of collisions.

Preferably, there is provided an evaluation module which, if the spatial-position measurement value α is above a limiting position value α_{G} stored in a limiting-position value memory, does not evaluate the distance measurement values delivered by the ultrasonic measuring head. The amount of the limiting position value α_{G} stored in a limiting-position value memory is influenced by a large number of factors, e.g. by the desired precision of the determination of the sludge level, by the frequency and strength of the influences disturbing the vertical orientation of the ultrasonic measuring head, etc. The limiting position value α_{G} which, when reached, will cause any further evaluation of the distance measurement values of the ultrasonic measuring head to stop, does not necessarily have to be identical with the limiting position value which, when the measurement value falls under it, will cause the evaluation of the distance measurement values to be resumed. In this manner, a hysteresis can be established which will prevent a permanent alteration between evaluation and non-evaluation in cases when the ultrasonic measuring head, e.g. due to a flow current, is permanently in a critical range of spatial positions.

According to a preferred embodiment, an evaluation module is provided in which, with the aid of the spatial-position measurement value α delivered by the positional sensor, the distance measurement value L′ supplied by the ultrasonic measuring head will be corrected into a corrected distance measurement value L, which is performed according to the relationship:

L=L′·cos α

By the correction carried out in this manner, the distance of the sludge level and respectively the height of the separation layer above the bottom of the basin are detected considerably more accurately in cases where the sludge-level probe is not arranged in an exactly vertical position. Thus, all further distance measurement values which are basically allowed for a further evaluation will become noticeably more precise.

Already with a spatial-position measurement value α of 25°, the geometric imprecision in case of a distance measurement value of 4 m is about 0.35 m, which, in the so-called dynamic sludge-level determination for determining the intensity maximum, will already correspond to the range which in this process is masked out at the bottom of the basin. Thus, when using the dynamic sludge-level determination, the described correction is virtually indispensable. Theoretically, an evaluation can be performed also for those distance measurement values which are detected at a relatively strong inclination of the sludge-level probe, so that a masking-out of these values could be completely omitted. However, distance measurement values above a critical limiting position value are relatively inaccurate, which is a consequence of various physical influences. The distance measurement value correction is thus particularly suitable in connection with the masking-out of distance measurement values in case of a spatial position above a limiting position value.

Preferably, the limiting position value is maximally 25° and, according to a particularly preferred embodiment, maximally 15° relative to the vertical line. In case of limiting position values above 25°, the geometric faults and the measuring inaccuracies are so large that the distance measurement values will become massively erroneous and also will be neither reliable nor be correctible with the required accuracy.

Preferably, the evaluation module has associated thereto a timer which will be started by the exceeding of the limiting position value and will run for a predetermined period of time, the evaluation module being arranged to output an error message if the spatial-position measurement value is above the limiting position value after said predetermined period of time. The predetermined period of time is selected to the effect that, under regular conditions, in a situation subsequent to a brief mechanical disturbance—e.g. after a collision with a cleaner beam—the spatial position of the ultrasonic measuring head should long be below the limiting position value again. If the spatial-position measurement value after the predetermined period of time is still above the limiting position value, a permanent disturbance may be assumed, depending on the prevailing conditions. The error message allows for a fast examination and respectively elimination of the permanent positional disturbance.

According to a further independent claim related to a sedimentation plant, there are provided a sedimentation basin, a beam-type cleaner and an ultrasonic sludge-level probe suspended into the sedimentation basin, wherein the sludge-level probe comprises the above described features.

According to a further independent method claim related to the determining of the sludge level in a sedimentation basin of a sedimentation plant which comprises a beam-type cleaner and an ultrasonic sludge-level probe according to any one of the claims related to the sludge-level probe, with the sludge-level probe being suspended into the sedimentation basin, the following method steps are provided:
continuous determination of the sludge level by evaluation of the distance measurement values,
continuous determination of the spatial position of the sludge-level probe from the spatial-position measurement values of the positional sensor fixedly associated to the ultrasonic measuring head, and
masking-out the distance measurement values if the spatial-position measurement values exceed a predetermined limiting position value.

In this manner, there is provided a reliable method, for use in sedimentation plants provided with a beam-type cleaner in the sedimentation basin, which is adapted to perform a reliable masking-out those distance measurement values that are caused by collision of the cleaner beams with the sludge-level probe and are useless for the determination of the sludge level height.

### BRIEF DESCRIPTION OF THE DRAWING

An embodiment of the invention will be explained in greater detail hereunder with reference to the drawing.

The FIGURE shows a longitudinal sectional view of a sedimentation plant comprising a sedimentation basin, a beam-type cleaner and an ultrasonic sludge-level probe.

### DETAILED DESCRIPTION OF THE ILLUSTRATIVE EMBODIMENTS

The sedimentation plant 10 illustrated in the FIGURE comprises a sedimentation basin 12 filled with waste water. The waste water contains a liquid 14 and solids which due to their weight will sink down to the bottom 16 of sedimentation basin 12, or will rise to the surface 20 of said waste-water liquid 14.

Associated to the sedimentation plant 10 is a beam-type cleaner 18 which in the region of the liquid surface 20 is operative to clear away solids floating on the surface and, on its way back over the bottom 16 of the basin, is operative to continuously convey the sunk solids towards a funnel (not illustrated) where the solids are pumped off. The beam-type cleaner 18 is formed by a plurality of beams 22 connected to each other by a continuous chain and driven by a suitable drive means.

A bar-like holding device 26 is provided for vertical suspension of a sludge-level probe 30 which is immersed into the liquid 14 slightly below the liquid surface 20. The sludge-level probe 30 comprises an ultrasonic measuring head 32 and a positional sensor 34, both of them rigidly arranged in a sludge-level probe housing.

Sludge-level probe 30 is suspended on said holding device 26 by means of a flexible rope or chain 36. However, the sludge-level probe can also be suspended on a rigid bar pivotally fastened to holding device 26.

When in their operating condition, the cleaner beams 22 of the beam-type cleaner 18 are moving along the liquid surface 20 in a horizontal plane and thus will inevitably collide with the sludge-level probe 30 and/or the suspension structure thereof. In the FIGURE, the moment of the collision is schematically indicated by interrupted lines. When a collision occurs, the cleaner beam 22′ will move the sludge-level probe 30′ out of the vertical spatial position, thereby causing the longitudinal axis 38 of sludge-level probe 30, which is also the axis of symmetry and respectively the measurement axis of the ultrasonic measuring head 32, to be tilted from the vertical into an oblique position.

The longitudinal axis 38 of the sludge-level probe is the measurement axis which the measurement by the ultrasonic measuring head 32 is related to. Only if the longitudinal axis 38 is oriented along a vertical line and the sludge-level probe 30 is suspended at a defined height, the height of the sludge level 40 above the bottom 16 of sedimentation basin 12 can be precisely determined from the distance measurement values supplied by the sludge-level probe 30. The spatial-position measurement value α, i.e. the spatial-position angle between a vertical line 44 and the longitudinal axis 38 of the sludge-level probe, should not be larger than 15° in order to make it still possible to obtain an acceptably precise result when determining the height h and the distance of sludge level 40, respectively.

On the land side, a control unit 46 comprising an evaluation module 48 is provided. Control unit 46 and evaluation module 48 are connected via electric data and supply lines to sludge-level probe 30 and respectively to ultrasonic measuring head 32 and positional sensor 34. The evaluation module 48 continuously receives measurement values from ultrasonic measuring head 32 and positional sensor 34.

A limiting-position value memory associated with evaluation module 48 has stored therein a limiting position value α_{G} for continuous comparison with the spatial-position measurement value α supplied by positional sensor 34. If the spatial-position measurement value α, i.e. the angle—detected by positional sensor 34—of said sludge-level-probe longitudinal axis 38 relative to the vertical line 44, exceeds the stored limiting position value α_{G}, the distance measurement values simultaneously transmitted by ultrasonic measuring head 32 will not be supplied to a further evaluation process. Only if the spatial-position measurement value α supplied by positional sensor 34 is below the limiting position value α_{G}, the distance measurement values of ultrasonic measuring head 32 will be supplied to a further evaluation.

In evaluation module 48, the distance measurement values L′ supplied to a further evaluation will undergo a correction to become the corrected measurement values L according to the relation:

L =L′·cos α

Thereby, it is safeguarded that, with a spatial-position measurement value 0<α<α_{G}, the distance measurement values L′ will be geometrically corrected. Of course, the correction can also be performed by reading a correction value from an input-output map. Also the height displacement of ultrasonic measuring head 32 in case of non-verticality can be additionally corrected.

Associated to evaluation module 48 is a timer which will be started each time that the limiting position value α_{G} first exceeds the limiting position value α_{G}. The timer will then run for a predetermined period of time during which the distance measurement values of ultrasonic measuring head 32 will not be supplied to a further evaluation. If, after lapse of the predetermined period of time, the spatial-position measurement value α is still above the limiting position value α_{G}, the evaluation module 48 will output an error message. The predetermined period of time is selected to the effect that, in case of normal operation, subsequent to a collision with the cleaner beam 22, the sludge-level probe 30 will have been pivoted back to a steady vertical position already for a longer time. Thus, in case of an error message, it is possible that a permanent disturbance has occurred which tends to keep the sludge-level probe 30 permanently out of the vertical position.

1. A sludge-level probe comprising:
a holding device;
a sludge-level ultrasonic measuring head, suspended from the holding device and arranged to be immersed into a liquid and operative to generate a distance measurement value; and
a positional sensor associated with the ultrasonic measuring head;
wherein the positional sensor is operable for determining a spatial-position measurement value (α) of the ultrasonic measuring head.

2. The sludge-level probe according to claim 1, further comprising an evaluation module operative to evaluate distance measurement value L′ supplied by the ultrasonic measuring head unless the spatial-position measurement value (α) reported by the positional sensor is above a limiting position value (α_{G}) stored in a limiting-position value memory.

3. The sludge-level probe according to claim 1, characterized in that, in an evaluation module, with the aid of the spatial-position measurement value (α) supplied by the positional sensor, the distance measurement value (L′) supplied by the ultrasonic measuring head is corrected to a corrected distance measurement value L according to the relation:
L=L′·cos α.

4. The sludge-level probe according to claim 2, wherein said limiting position value (α_{G}) is 25° or less.

5. The sludge-level probe according to claims 1-4, further comprising:
a timer, arranged to be started by the spatial-position measurement value (α) exceeding of a limiting position value (α_{G}) and to run for a predetermined period of time; and
an evaluation module operative to emit an error message if, after the predetermined period of time, the spatial-position measurement value (α) is above the limiting position value (α_{G}).

6. A sedimentation plant, comprising:
a sedimentation basin,
a beam-type cleaner, and
the ultrasonic sludge-level probe according to claim 1, wherein the sludge-level probe is suspended into the sedimentation basin.

7. A method for determining sludge levels in a sedimentation basin of a sedimentation plant comprising a beam-type cleaner and the ultrasonic sludge-level probe according to claim 1, the sludge-level probe being suspended into the sedimentation basin, the method comprising:
continuous determination of height h of the sludge level by evaluation of the distance measurement values of the ultrasonic measuring head;
continuous determination of a spatial position of the sludge-level probe from the spatial-position measurement values (α) of the positional sensory; and
masking-out the distance measurement values if the spatial-position measurement value (α) exceeds a predetermined limiting position value (α_{G}).

8. The method according to claim 7, further comprising:
with the aid of the spatial-position measurement value (α) supplied by the positional sensor, correcting the distance measurement value L′ supplied by the ultrasonic measuring head to a corrected distance measurement value (L) according to the relation:
L=L′·cos α.

9. The sludge-level probe according to claim 2, wherein said limiting position value (α_{G}) is 15° or less.

10. The sludge-level probe according to claim 2, characterized in that, in the evaluation module, with the aid of the spatial-position measurement value (α) supplied by the positional sensor, the distance measurement value (L′) supplied by the ultrasonic measuring head is corrected to a corrected distance measurement value L according to the relation:
L=L′·cos α.

11. The sludge-level probe according to claim 10, wherein said limiting position value (α_{G}) is 15° or less.

12. The sludge-level probe according to claim 2, further comprising:
a timer, arranged to be started by the spatial-position measurement value (α) exceeding of a limiting position value (α_{G}) and to run for a predetermined period of time; and
an evaluation module operative to emit an error message if, after said predetermined period of time, the spatial-position measurement value (α) is above the limiting position value (α_{G}).

13. The sludge-level probe according to claim 3, further comprising:
a timer, arranged to be started by the spatial-position measurement value (α) exceeding of a limiting position value (α_{G}) and to run for a predetermined period of time; and
an evaluation module operative to emit an error message if, after said predetermined period of time, the spatial-position measurement value (α) is above the limiting position value (α_{G}).

14. The sludge-level probe according to claim 10, further comprising:
a timer, arranged to be started by the spatial-position measurement value (α) exceeding of a limiting position value (α_{G}) and to run for a predetermined period of time; and
an evaluation module operative to emit an error message if, after said predetermined period of time, the spatial-position measurement value (α) is above the limiting position value (α_{G}).
